(19) United States
(12) Patent Application Publication
(10) Pub. No.: US 2019/0042961 A1
(43) Pub. Date: Feb. 7, 2019

(54) MULTI-MODE DATA COLLECTION AND TRAVELER PROCESSING

(71) Applicant: Securiport LLC, Washington, DC (US)

(72) Inventors: Nathan Thomas CARPENTER, Severn, MD (US); Antonio Enrique Mario SEGURA, McLean, VA (US)

(21) Appl. No.: 15/670,806

(22) Filed: Aug. 7, 2017

(51) Int. Cl. G06N 7/02; G06F 17/30

(52) U.S. Cl. CPC G06N 7/02; G06F 17/30011

(57) ABSTRACT

A technique includes receiving, for a traveler, traveler information via a plurality of different information collection modes, determining a reliability score for each of the plurality of information collection modes, determining a cumulative score for the traveler based on the reliability score for each of the plurality of information collection modes, determining whether the cumulative score is greater than or equal to a threshold, performing traveler processing based on the received traveler information if the cumulative score is greater than or equal to the threshold, and otherwise, receiving for the traveler, traveler information via an additional different information collection mode if the cumulative score is less than the threshold.

### TECHNICAL FIELD

This description relates to multi-mode data collection and traveler processing.

### BACKGROUND

Travelers via land, air and sea typically go through one or more checkpoints in which their travel documents, such as a driver's license, a passport and/or a boarding pass, may be checked against a database.

### SUMMARY

According to an example implementation, a method may include receiving, for a traveler, traveler information via a plurality of different information collection modes, determining a reliability score for each of the plurality of information collection modes, determining a cumulative score for the traveler based on the reliability score for each of the plurality of information collection modes, determining whether the cumulative score is greater than or equal to a threshold or falls within a confidence interval, performing traveler processing based on the received traveler information if the cumulative score is greater than or equal to the threshold or falls within a confidence interval, and otherwise, receiving for the traveler, traveler information via an additional different information collection mode if the cumulative score is less than the threshold or falls outside a confidence interval.

According to an example implementation, an apparatus includes at least one processor and at least one memory including computer instructions, when executed by the at least one processor, cause the apparatus to: receive, for a traveler, traveler information via a plurality of different information collection modes, determine a reliability score for each of the plurality of information collection modes, determine a cumulative score for the traveler based on the reliability score for each of the plurality of information collection modes, determine whether the cumulative score is greater than or equal to a threshold or falls within a confidence interval, perform traveler processing based on the received traveler information if the cumulative score is greater than or equal to the threshold or falls within a confidence interval, and otherwise, receive for the traveler, traveler information via an additional different information collection mode if the cumulative score is less than the threshold or falls outside a confidence interval.

According to an example implementation, an apparatus includes means for receiving, for a traveler, traveler information via a plurality of different information collection modes, means for determining a reliability score for each of the plurality of information collection modes, means for determining a cumulative score for the traveler based on the reliability score for each of the plurality of information collection modes, means for determining whether the cumulative score is greater than or equal to a threshold or falls within a confidence interval, means for performing traveler processing based on the received traveler information if the cumulative score is greater than or equal to the threshold or falls within a confidence interval, and means for otherwise, receiving for the traveler, traveler information via an additional different information collection mode if the cumulative score is less than the threshold or falls outside a confidence interval.

According to an example implementation, a computer program product includes a computer-readable storage medium and storing executable code that, when executed by at least one data processing apparatus, is configured to cause the at least one data processing apparatus to perform a method including: receiving, for a traveler, traveler information via a plurality of different information collection modes, determining a reliability score for each of the plurality of information collection modes, determining a cumulative score for the traveler based on the reliability score for each of the plurality of information collection modes, determining whether the cumulative score is greater than or equal to a threshold or falls within a confidence interval, performing traveler processing based on the received traveler information if the cumulative score is greater than or equal to the threshold or falls within a confidence interval, and otherwise, receiving for the traveler, traveler information via an additional different information collection mode if the cumulative score is less than the threshold or falls outside a confidence interval.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a system according to an example implementation.

FIG. 2 is a flow chart illustrating operation of a system according to an example implementation.

FIG. 3 is a block diagram of a system according to another example implementation.

### DETAILED DESCRIPTION

According to an example implementation, travelers via land, air and sea typically go through one or more checkpoints in which their travel documents, such as a driver's license, a passport and/or a boarding pass, may be checked against a database. In some cases, biometric information for the traveler may be used to perform some types of traveler processing. For example, in some cases, traveler processing may be performed for the traveler in which one or more checks may be performed for the traveler, e.g., such as a traveler verification process, a background check, an identity fraud check, and/or other traveler processing. However, one or more variations in traveler processing (e.g., variations or differences in one or more of: general condition of travel documents, physical traveler characteristics, biometric device capabilities and characteristics, surrounding environmental conditions, and the like) may make it challenging to perform reliable and consistent traveler processing. For example, one or more variations in these factors may decrease the reliability of traveler processing (e.g., causing an increase in false positives or false negatives when a traveler is checked against a database), or one or more variations may increase a time required to perform traveler processing, causing inconvenience for the traveler.

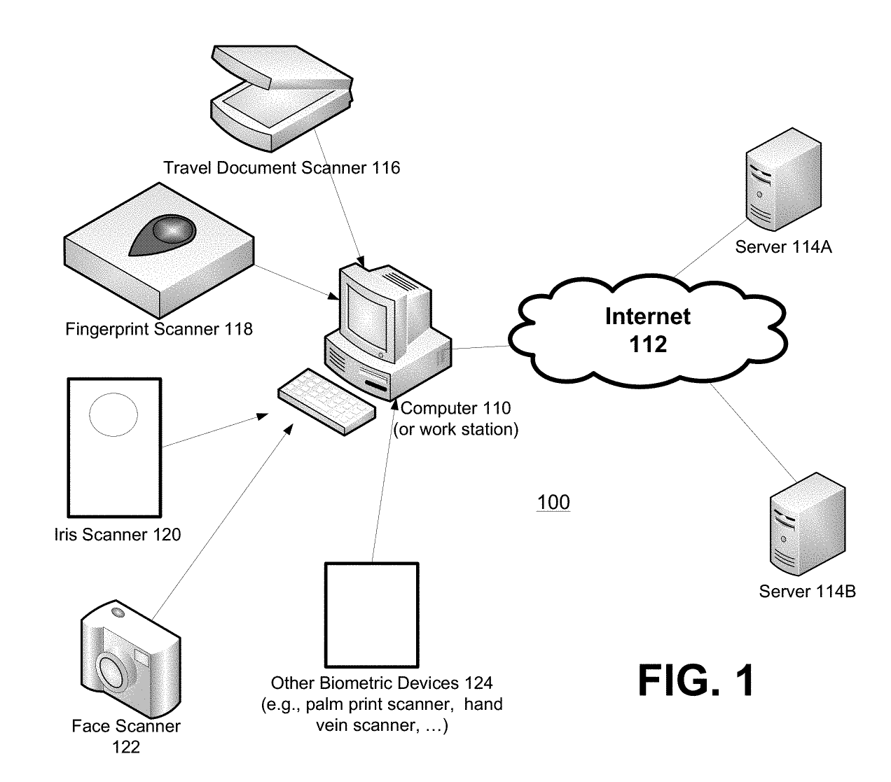

FIG. 1 is a diagram illustrating a system according to an example implementation. System 100 may include a computer 110 (which may also be referred to as a work station or user terminal). Computer 110 may include a processor for executing software or instructions, memory (e.g., including random access memory (RAM), and/or a hard disk drive (HDD)) for storing software (or computer instructions) and data. Computer 110 may also include one or more input/output (I/O) devices, such as a mouse or pointing device, a keyboard, and a display or monitor. Computer 110 may be connected to or in communication with a plurality of traveler information collection devices, such as, for example, devices 116, 118, 120, 122 and 124. The traveler information collection devices may include a variety of devices to collect different modes (e.g., different types) of traveler information.

The traveler information collection devices may include a travel document scanner 116 to receive and scan one or more travel documents for a traveler. Example travel documents may include a driver's license, a passport, a visa, a national identification card (national ID card), a boarding pass or ticket (e.g., a train, boat or airline boarding pass or ticket), or other travel document that may be associated with, assigned to, and/or identify a traveler. For example, the travel document scanner 116 may receive and (e.g., optically) scan a travel document to generate a digitized copy of the travel document.

The traveler information collection devices may also include, for example, a plurality of biometric devices for performing a biometric scan or generating biometric data for the traveler. The biometric devices may include biometric devices of different biometric modes (e.g., for providing different types or different modes of biometric data). A fingerprint scanner 118 may scan one or more fingerprints of a traveler, e.g., to generate a digitized copy of the finger print(s). The scanned fingerprint may be compared to a database of fingerprints. An iris (or eye) scanner 120 may perform iris (or an iris portion of the eye) scanning on a traveler to generate a digitized scan or copy of the traveler's eye or iris. The scanned iris for the traveler may be compared to a database of iris scans or iris data. A face scanner 122 may obtain a face (or facial) scan of a traveler, e.g., so that the face scan of the traveler may be compared to face scans or facial data in a database, such as for facial recognition. Other biometric devices 124 may also be provided (e.g., different modes of biometric devices), e.g., such as a palm print scanner to obtain a scan of the traveler's palm print, a hand vein scanner to obtain a scan of the veins (and other structures) of the traveler's hands, etc. These are merely a few example biometric devices that may be used, and other biometric devices or scanners may also be used.

Computer 110 may obtain traveler information for a traveler, e.g., including traveler information for a plurality of different information collection modes. For example, the computer may obtain a scanned travel document and a biometric scan via at least one biometric mode. As other examples, computer 110 may obtain a fingerprint and an iris scan of a traveler, or may obtain a scanned passport (or other travel document) and a fingerprint, or may obtain a scanned driver's license, an iris scan and a face scan. Computer 110 may then perform traveler processing for the traveler based on the collected traveler information. Computer 110 may perform traveler processing based on information (e.g., a database) store locally, and/or computer 110 may send one or more queries or requests to one or more databases, which may be stored on one or more servers or other computers, such as servers 114A, 114B, etc. Servers 114A, 114B may be connected to computer 110 via a network such as Internet 112.

According to an example implementation, traveler processing based on the received traveler information comprises performing one or more of the following: 1) a traveler verification process in which it is verified that the received traveler information for the plurality of different information collection modes is consistent or for the same traveler. A traveler verification may include checking that collected traveler information (e.g., name and fingerprint(s) data on passport and/or fingerprint scan collected from traveler) is consistent, and/or is consistent with what is on file, and/or is consistent with a traveler (e.g., TSA) database. If a traveler verification fails for a traveler (e.g., an inconsistency is found), then, for example, the traveler may be not allowed to travel or at least pulled aside for additional questioning/further investigation. 2) A background check for the traveler to determine if at least a portion of the received traveler information matches information stored in one or more background check lists (e.g., Interpol, no fly list, watch list, person-of-interest list). If any of the collected traveler information for a traveler matches (or returns a minimum score for biometrics comparison) on one of these background checks, then, for example, the traveler may be not allowed to travel or at least pulled aside for additional questioning/further investigation. 3) An identity fraud check in which it is determined whether at least a portion of the received traveler information was previously presented or received for a different traveler. And/or 4) allowing (e.g., if sufficient traveler information has been received/obtained and/or verified that satisfies a threshold value or confidence interval) or preventing (e.g., if insufficient traveler information has been received and/or verified, or the traveler information does not meet a threshold value and/or confidence interval) the traveler to pass a check point (e.g., to allow/not allow the traveler to board a plane, bus, boat or other mode of transportation, and/or to be admitted or allowed to enter a city or country or other area), and/or obtaining further information from or questioning the traveler. Thus, an identity fraud check may detect an inconsistency (or inconsistent previous use) between collected biometrics and a travel document for a traveler. For example, if a passport is being presented by a traveler along with a first set of fingerprints, but a database shows that the same passport was previously presented along with a different or second set of fingerprints, then this might be flagged as a possible identity fraud, and the traveler may be not allowed to travel or at least may be pulled aside for additional questioning/further investigation. These are merely a few examples of traveler processing, and other types of traveler processing may also be performed.

As noted, one or more variations in traveler processing (e.g., variations or differences in one or more of: travel documents, traveler characteristics, biometric device characteristics, environmental conditions, and the like) may make it challenging to perform reliable traveler processing. For example, a set of collected traveler information under one set of conditions or characteristics may be very reliable, but the same type of collected traveler information under a different set of conditions or characteristics may be very unreliable.

For example, not all travel documents are the same and/or not all travel documents have the same reliability. Different characteristics of a travel document may cause a travel document to be more reliable or less reliable. By way of illustrative example, some travel document characteristics that may impact reliability of the travel document may include, for example: a type of travel document (e.g., a passport may be considered more reliable than a driver's license); a country that issued the travel document (e.g., some countries may be more reliable, or less likely to produce a fraudulent travel document, than other countries); whether the travel document is hand-written or typed (e.g., a hand-written travel document may be considered very unreliable, while a typed travel document may be considered more reliable); whether or not the document is damaged or worn; whether or not the travel document includes or uses one or more security features, such as, for example, one or more of the following security features (e.g., use or presence in the travel document of one or more security features may make the travel document increasingly more reliable): a digitally-printed photograph; a watermark; a radio frequency identification (RFID) chip; thermochromatic ink (e.g., which may vary under different circumstances, such as changing color at different temperatures); and a hologram.

In addition, some characteristics of the traveler may make the traveler information more or less reliable, e.g., depending on the circumstances and/or the biometric mode or biometric device used to collect the traveler information. For example, some facial recognition software may work best on fair skinned or white people (e.g., based on the subjects/people that were used to develop some facial recognition software), and may not work as well for travelers with darker color skin. Thus, the color of skin, race and/or country of origin of a traveler may make a face scan and/or facial recognition for a traveler more reliable (e.g., for a fair skin traveler, or races or countries of origin that are typically fair or lighter color skin) or less reliable (e.g., for travelers with darker skin or with a race or country of original that may typically have dark or darker color skin). Also, a country of origin may indicate that a travel document is more reliable (e.g., from certain western countries or from a country where fraud is less of a problem) or less reliable (e.g., a travel document issued from a country where fraud is a significant problem). Also, an occupation and/or age of a traveler may indicate that received traveler information for a traveler is more reliable or less reliable. For example, an occupation of a mine worker, construction worker, or other job that may involve manual labor may be associated with wearing down or altering of the traveler's fingerprints over time, or in some cases, the traveler may have damaged hands or fingers that may prevent a high quality fingerprint or handprint from even being obtained for such traveler. On the other hand, fingerprints for travelers having an occupation as an office worker (e.g., involving little to no manual labor) may indicate or may be associated with a more reliable fingerprint scan because the fingerprints or palm print are more likely to allow a high quality fingerprint scan, and/or also such fingerprints are more likely to be stable or consistent over a period of time for the traveler who is an office worker. Also, as a person ages, the fingerprints and/or palm print may change, wear, or degrade over time. Thus, a fingerprint or palm print for a younger person (e.g., less than 40 years old) may be considered to be more reliable than a fingerprint or palm print of an older person (e.g., 60+ years old), as an illustrative example. While one or more traveler characteristics may impact a reliability of some traveler information collection modes (e.g., travel document, face scan/recognition, fingerprint, palm print), one or more of such traveler characteristics may have little to no impact on reliability of other traveler information collection modes (e.g., such as iris scan, because, for example, at least in some cases, a person's iris may not change substantially over time as they age).

Also, one or more biometric device characteristics may impact reliability of a biometric scan received (or traveler information collected) from such biometric device. Thus, one or more biometric device characteristics may make a biometric scan from such device more reliable or less reliable. Some example characteristics of a biometric device that may impact information (or biometric scan) reliability may include: a type of the device (e.g., an ultra sound fingerprint scanner may produce higher quality or more reliable fingerprint scans than an optical fingerprint scanner); a model or manufacturer of the device (e.g., some models or manufacturers may be better, higher quality, perform better, . . . ); an age of the device (e.g., operation of a biometric device may degrade over time or a newer device may offer improved performance, so an older biometric device may be associated with a less reliable biometric scan); speed of the device to perform a biometric scan (a faster scanning device may be favored, as providing improved or faster traveler experience, at least in some cases); a quality of the data capture when the device performs a biometric scan (e.g., some devices may provide or produce a higher-resolution or more detailed scan than other devices); one or more performance characteristics of the device; and environmental conditions recommended or required for operation of the device (e.g., at least in some cases or certain countries that may have higher temperature or humidity, a device that has a wider recommended operating range for temperature and/or humidity may provide better performance than other devices that have a narrower operating range for temperature and humidity).

Also, one or more environmental conditions may impact reliability of a biometric scan received (or traveler information collected) from such biometric device. For example, if a temperature and/or humidity at an airport, train station, or other location where traveler processing may be performed is relatively hot and/or humid, and such temperature and/or humidity are outside of (e.g., greater than) the required or suggested operating conditions of a biometric device, then this may render a biometric scan obtained with such environmental conditions to be less reliable, as compared to a biometric scan that is performed in environmental conditions that are within a suggested operating range for the biometric device. Furthermore, if a temperature and/or humidity at an airport, train station, etc., or other location where traveler processing may be performed is relatively high, e.g., then this may cause a traveler to have moist or sweaty fingers and/or palms, which may, for example, decrease the accuracy or performance of a fingerprint or palm print scan. Thus, for example, such a relatively high temperature and/or humidity (e.g., even though these environmental conditions may be within a recommended range for the device) may cause any resulting fingerprints and/or palm prints to have a lower reliability. Likewise, if a lighting where a face scan is performed for a traveler (e.g., at an airport) is very poor (e.g., inadequate lighting, too much back lighting), then this may cause any such resulting face scan of a traveler obtained with such poor lighting conditions to have a lower reliability, e.g., as compared to the same face scan performed under adequate lighting conditions.

Therefore, according to an example implementation, a technique or method may be performed, which may include, for example:

1) Receiving, for a traveler, traveler information via a plurality of different information collection modes. For example, the receiving may include receiving a scanned traveler document and at least one biometric scan, and/or a plurality of biometric scans, such as a biometric scan for each of a plurality of different biometric modes for a traveler.

2) Determining a reliability score for each of the plurality of information collection modes. Determining a reliability score may include, for example, determining a reliability score for the scanned travel document and/or for each of one or more biometric scans for the traveler, where a reliability score may be based on a number of different criteria including a set of conditions or characteristics. Thus, by way of illustrative example, a reliability score may be determined for an information collection mode (e.g., for a travel document or a biometric scan) based on one or more: travel document characteristic(s), traveler characteristic(s), biometric device characteristic(s), environmental condition(s), for the collected traveler information, or other condition or characteristic. Thus, as one or more of these conditions or characteristics may change for information collected for a traveler, the reliability score for an information collection mode may vary or change.

3) Determining a cumulative score for the traveler based on the reliability score for each of the plurality of information collection modes. For example, a cumulative score may be determined as a sum of the reliability scores for the plurality of information collection modes. For example, if a visa (as a travel document) is received, and an iris scan, then a cumulative score may be determined as a sum of the reliability score of the visa and a reliability score of the iris scan. This is merely one illustrative example of how a cumulative score for a traveler may be determined. Furthermore, a cumulative score for a traveler may be updated or revised if a new traveler information (e.g., with a different information collection mode) is received (e.g., a new or revised biometric scan is received, or a new or different travel document is received), and/or if one or more of the conditions or characteristics change that may impact a reliability score of a received traveler information.

4) Determining whether the cumulative score is greater than or equal to a threshold or falls within a confidence interval. By comparing the cumulative score to a threshold, the computer 110 may determine whether a sufficient quantity and/or quality of traveler information has been received to reliably perform traveler processing. Thus, the cumulative score may provide a reliability and/quality indication for the received traveler information. Whether the computer 110 performs traveler processing, or obtains additional traveler information before performing traveler processing, depending on whether or not the cumulative score is greater than or equal to the threshold or falls within the confidence interval.

5) Performing traveler processing based on the received traveler information if the cumulative score is greater than or equal to the threshold. Thus, for example, if the cumulative score is greater than a threshold (e.g., indicating that the received traveler information is of sufficient quality, quantity and/or reliability) or falls within the confidence interval (indicating that the information is statistically adequate), computer 110 may then perform traveler processing for the traveler, which may include, e.g., performing, either locally on computer 110, or by sending a query or request to one or more servers 114A, 114B, a traveler verification process, a background check for the traveler, and/or an identity fraud check, as illustrative examples of traveler processing. If the traveler passes the traveler processing, then the traveler may be allowed to pass through security or security check and board the aircraft, train, boat to travel, or may be allowed into the country, etc. If the traveler does not pass traveler processing (e.g., the traveler fails one or more checks associated with traveler verification, background check, and/or identity fraud check), then the traveler may be detained for further investigation, or additional traveler information (e.g., further biometric scans) may be obtained from the traveler, and the traveler processing may be repeated, for example. Also, if the traveler fails traveler processing, then the traveler may not be allowed to board the aircraft and/or may not be allowed to enter the country, and may be detained by customs or law enforcement officers.

6) And, otherwise, if the cumulative score is greater than or equal to the threshold or falls within the confidence interval, receiving for the traveler, traveler information via an additional different information collection mode if the cumulative score is less than the threshold. Thus, if the if the cumulative score is less than the threshold or outside the confidence interval (e.g., indicating that the received traveler information is Not of sufficient quality, quantity and/or reliability), then additional traveler information should be obtained. For example, if a cumulative score based on reliability scores for a Visa (e.g., with little or no security features) and a fingerprint scan is less than a threshold, then computer 110 may request and obtain traveler information for an additional information collection mode (e.g., an additional biometric scan) before performing traveler processing. For example, computer 110 may then receive a face scan of the traveler, and determine a reliability score for the face scan. Then, an updated cumulative score for the traveler may be determined, e.g., as a sum of the reliability scores for the Visa, fingerprint scan and face scan. Thus, in this example, a higher cumulative score would typically be expected based on this additional traveler information (e.g., based on receiving the new traveler information, such as the face scan in this example). If the updated cumulative score for the traveler is greater than or equal to the threshold, then this indicates that computer 110 has received sufficient quality and quantity (e.g., indicating sufficient reliability) of traveler information, and traveler processing may be performed without requiring additional traveler information.

As noted, computer 110 may, for example, receive traveler information from one or more information collection devices, may determine a reliability score for each of a plurality of information collection devices and/or biometric devices, may determine a cumulative score for a traveler based on received traveler information, may determine whether the cumulative score is greater than or equal to a threshold or within a confidence interval (or whether additional traveler information is required based on the cumulative score being less than the threshold), and then performing traveler processing if the cumulative score is greater than the threshold.

In addition, computer 110 may receive and store, or may be configured with, various reliability scores (or information contributing to such a reliability scores) for each of a plurality information collection modes for a plurality of different conditions or characteristics (e.g., under different conditions or characteristics that may affect the reliability scores). As noted, a reliability score for an information collection mode (e.g., for a travel document and/or a biometric scan) may be affected by one or more conditions or characteristics, such as, for example, a characteristic of a travel document for the traveler, a characteristic of the traveler, an environmental condition, and a number of biometric scan entries in a database corresponding to a biometric mode (e.g., the higher number of available scans in a database for a biometric scan may make that type or mode of biometric scan more useful or reliable in performing some types of traveler processing, and a biometric scan may be less useful less reliable and/or less desirable, at least in some cases, if there are fewer data entries in a database for a biometric mode), and/or a characteristic of a device used to perform a biometric scan where the information collection mode comprises a biometric scan of the traveler.

According to an illustrative example, a threshold of 100 may be used to determine whether a sufficient quality and quantity of traveler information has been received to perform traveler processing. A reliability score may be determined by computer 110 for each of a variety of different travel documents and/or biometric scans, under different conditions or characteristics. A number of illustrative examples will now be provided.

According to an example implementation, a reliability score may be assigned to each of the following travel documents:
a passport—30 points
a visa—25 points
a national identification card—22 points
a driver's license—25 points
an airline boarding pass—10 points

For example, these reliability scores are for typed documents, and a fixed score of only 10 points may be applied for any hand-written travel document. Also, a 10-point deduction for a country of origin or issuing country for a list of high risk countries (such list of high risk countries would be configured or input to computer 110, for example). Thus, for example, a hand-written travel document (initially worth 10 points) may have a 10-point deduction if issued by a high risk country, resulting in a reliability score of zero (0) for such travel document. Or, in another example, a typed passport, initially worth 30 points, would receive a 10-point deduction if issued from a country that is high risk, resulting in a reliability score for such passport of 20 points.

In addition, if the travel document is typed, the reliability score for such travel document may be increased based on the presence of one or more security features in the travel document. This reliability score enhancement based on security features may be applied, for example, only for some travel documents (e.g., only for a passport, a visa, a national ID card, and a driver's license). Some example reliability score enhancements for travel documents, based on a presence of one or more security features, may include, by way of illustrative example:
a digitally-printed photograph—+3 points
a watermark—+3 points
a radio frequency identification (RFID) chip—+4 points
thermochromatic ink—+2 points
a hologram—+3 points.

Thus, for example, a typed passport (base score of 30 points) that includes a digitally-printed photograph (+3 points), a watermark (+3 points), and a radio frequency identification (RFID) chip (+4 points) would therefore have a reliability score of 40 points.

Some example reliability scores, by way of illustrative examples, are provided below for some biometric modes (or information collection modes):
Face scan—40 points
Fingerprint—60 points
Iris scan—80 points

As noted above, the reliability scores for different biometric modes may be affected by: e.g., one or more characteristics of the traveler, one or more environmental conditions, and/or one or more characteristics of a device used to perform a biometric scan or information collection device.

For example, certain races or darker skin color of a traveler may be less reliable for a face scan. Thus, a reliability score for a face scan for a traveler with certain races or darker skin colors may result in a 10-point deduction from the reliability score for a face scan for such traveler, causing a reliability score of 40−10=30 points for such a traveler, for example.

Similarly, for older travelers, or for manual labor-related occupations (e.g., mine worker) may be less reliable for fingerprint scan, and thus, a fingerprint scan for such a traveler with one of these characteristics may result in a 10-point deduction of the reliability score for a fingerprint scan. Thus, a fingerprint scan from such a traveler may have a reliability score of 40−10=30 points, for example.

As noted, certain environmental conditions may be less reliable conditions for obtaining some types of biometric scans. For example, relatively high temperature (e.g., above 85 degrees Fahrenheit) and/or a relatively high humidity (e.g., 90% humidity or above) may typically cause moisture or sweating on hands/fingers that may make fingerprints and palm prints less reliable or lower quality. Thus, if such conditions are present at a station, airport, or other location where a biometric scan may be taken or received from a traveler, then a 10-point deduction may be applied to such fingerprint or palm print. Also, a poor lighting condition (e.g., low lighting or back lighting) may cause a face scan to be less reliable or lower quality. Thus, a face scan in such lighting conditions may cause a 10-point deduction for a face scan (e.g., resulting in a reliability score for a face scan in such conditions of 40−10=30 points).

Moreover, if environmental conditions (e.g., temperature, humidity, and/or lighting) are outside of required or recommended operating range of a biometric device, then this may also result in a specific point deduction, or in the narrowing of the confidence interval, or may result in the reliability score for such biometric device (operating outside of the recommended range) to be a low (or lower) value or even zero (e.g., thus, causing such biometric scan to be deemed to have little value or even no value or reliability, respectively, as part of the analysis of collected traveler information, for example).

Also, as noted, a characteristic of a device used to perform a biometric scan may affect a reliability score of a scan provided by such biometric device. For example, a type of the device, a model or manufacturer of the device, and/or an age of the device may impact the reliability score for a scan from such device. By way of illustrative examples, a certain device (e.g., an optical fingerprint scanner), or any biometric device older than 5 years may receive a 10-point deduction for such biometric scan, or result in the narrowing of the confidence interval of the scan. A quality (e.g., a scan resolution, or a number of horizontal and vertical pixels in a scanned image) of the data capture or one or more performance characteristics of the device may affect the reliability score from such device. For example, a quality (e.g., scan resolution) above a first threshold may receive a 10-point increase (e.g., increased reliability over average quality device or over average quality scan), and a quality (e.g., quality of scan) below a second threshold may have a 10-point deduction (e.g., lower quality scan or device is associated with decreased reliability), which can also be reflected as a confidence interval.

According to an example implementation, the information collection modes (e.g., including the different biometric modes) may be ranked, e.g., based upon a reliability score determined for each of the information collection modes (e.g., based on different types of travel documents and different biometric modes). For example, computer 110 may receive a scanned travel document and a highest ranked biometric scan for the traveler. Also, the ranking of reliability scores for different biometric scans/biometric modes for the traveler may be based on other information, such as, for example, one or more environmental conditions, a characteristic(s) of each of the biometric devices (or information collected devices), or other information. Thus, according to an example implementation, based on information received by the computer 110 (e.g., including information such as biometric device characteristics, environmental conditions, traveler characteristics, or other conditions or characteristics), computer 110 may request and obtain biometric scan, such as, for example, a highest ranked biometric scan. Or computer 110 may request and obtain a biometric scan that is determined or calculated to provide (along with any received travel document) a cumulative score that is greater than or equal to the threshold. Or, the computer 110 may indicate multiple biometric scans that may be preferably received to provide a cumulative score greater than a threshold or within a confidence interval.

According to an illustrative example, a traveler passing through security check at an airport or other location may present a typed passport, with security features that increases the reliability score to 40 points. Also, the traveler presents an airline ticket or airline boarding pass with a reliability score of 10 points. A face scan for the traveler is performed, but low lighting decreases the reliability score for such face scan to 40−10=30 points. Thus, in this example, the cumulative score for the traveler, after receiving traveler information of passport (40 points), boarding pass (10 points) and face scan (30 points) is 80 points, which is 20 points below the 100-point threshold. Thus, in this example, the computer 110 indicates (e.g., on a display via a graphical user interface) that either a fingerprint (e.g., 60 points), palm print (e.g., 60 points) or iris scan (e.g., 80 points) may be received, and either of these would be sufficient to provide the required quantity and quality of information to perform traveler processing. Or alternatively, if the occupation of the traveler indicated on the passport (or other presented travel document) is indicated as manual labor, mine worker, etc., or an age of the traveler is greater than a threshold, then the reliability score of a fingerprint or palm print for such a traveler. Depending on how such reliability scores are configured (e.g., to be either decreased slightly, or to be decreased to zero or a very low value), the fingerprint or palm print may still be of sufficient reliability score (e.g., 20+ points), or the reliability score for such a print may be less than 20 points. For example, in the case where a fingerprint and palm print for such a traveler is configured to be less than 20 points, then the computer 110 may indicate, for this situation, that a iris scan is required from the traveler (e.g., as the only remaining biometric mode with a score sufficient to make the cumulative score greater than the threshold, for example), before traveler processing can be performed. After receiving the iris scan (80 points), computer 110 would then re-compute the cumulative score for the traveler, where it may be the case where the cumulative score for all the received traveler information is greater than or equal to the threshold. In such case, the traveler processing would then be performed based on such traveler information. E.g., a verification process, background check and/or identify fraud check may be performed based on one or more or all of the received traveler information (e.g., based on scanned travel document, received fingerprint and/or based on received iris scan).

According to another example implementation, a traveler may present a travel document worth, say, 50 points (including security enhancements). The computer 110 may then use the various characteristics and conditions to determine a reliability score for various biometric modes for the traveler, which may include: face scan—40 points; fingerprint—60 points; palm print 60 points; iris scan—80 points. The computer 110 may rank these (remaining) biometric modes according to reliability score, and may then request and obtain from the traveler a biometric scan from a highest ranked biometric mode (e.g., an iris scan in this example, of 80 points). Or, the computer 110 may indicate a list of acceptable biometric modes (and may also indicate the reliability score for each), e.g., where the computer 110 may indicate a list of: fingerprint, palm print, and iris scan as each providing a sufficient reliability score to provide a cumulative score that is greater than or equal to the threshold of 100 points, and thus, provide sufficient traveler information to allow traveler processing to be performed.

Alternatively, computer 110 may receive a travel document, and a biometric scan for a default biometric mode, such as a fingerprint. For example, in some countries, laws or regulations may require that a traveler present at least one fingerprint scan for traveler processing. Computer 110 may determine a reliability score for each of the received travel document and the received fingerprint (e.g., based on the conditions and/ characteristics), compute the cumulative score based on these two sets of received traveler information. If the cumulative score is greater than or equal to the threshold, then computer 110 may perform traveler processing. On the other hand, if the cumulative score is less than the threshold, then the computer 110 may request and obtain a biometric scan for a highest remaining biometric mode. For example, if iris scan is the highest (based on the ranking performed by the computer 110) ranked biometric scan/mode that is remaining (or not yet obtained), then the computer 110 may request and obtain a iris scan from the traveler. Then all the collected traveler information (e.g., for which a cumulative score is now greater than the threshold) may be used to perform traveler processing. Alternatively, computer 110 may display a list of possible or acceptable biometric modes, where each of the acceptable biometric modes is estimated or determined to provide a biometric scan of the traveler that would have a reliability score sufficient (also taking into account the score of the travel document) to result in a cumulative score that is greater than or equal to the threshold, and thus estimated to be sufficient to perform traveler processing for the traveler. For example, the biometric modes (e.g., face scan) that, under the conditions and characteristics, would not have a sufficient reliability score to generate a cumulate score greater than or equal to the threshold, would typically be omitted from such a displayed or recommended list of biometric modes for the traveler.

As noted, there may be some information (e.g., characteristics and/or conditions) that may affect a reliability score for one or more information collection modes. According to an example implementation, some of the characteristics and/or conditions may be configured (e.g., pre-configured) in a static manner, while other characteristics and/or conditions may be configured in a dynamic manner based on the currently detected or measured condition(s) and/or characteristic. For example, device characteristics for each (or one or more) biometric devices may be set or pre-configured, e.g., since these device characteristics may be typically known in advance, such as a type of device, a model or manufacturer of the device, an age of the device (or date of manufacture), a quality or performance characteristics (e.g., scan resolution). Also, in some cases, some environmental conditions may be measured in advance, or estimated, such as: lighting condition, expected or average temperature or humidity, etc. On the other hand, some examples of characteristics and/or conditions that may be determined or configured dynamically (e.g., based on current conditions or a current traveler, or determined in real-time) may include, for example: a traveler characteristic (e.g., based on characteristics of the traveler indicated by the travel document), such as age, race, occupation, country or origin or country of citizenship, etc. Likewise, one or more current environmental conditions may be measured or determined, and used to determine reliability scores for one or more information collection modes. For example, computer 110 may include (or may be connected to) a temperature and/or humidity sensor to measure current temperature and/or humidity at an airport or other location where a fingerprint palm print may be taken, a light sensor to measure light conditions where a traveler may have a face scan performed, etc. Thus, a reliability score for each collection mode may be based on one or more static or pre-configured conditions or characteristics, one or more dynamic or currently measured conditions or characteristics, or a combination of both.

According to an example implementation, by using one or more of the techniques or example implementations described herein (e.g., including one or more of receiving traveler information, determining a reliability score for each traveler information, determining a cumulative score, and either proceeding to perform traveler processing, or if necessary, obtaining further traveler information until a sufficient cumulative score is obtained), this may provide a number of advantages, such as: the computer 110 may collect less traveler information, or may collect only required traveler information to achieve a cumulative score that is of sufficient quality or reliability, and/or avoid obtaining unnecessary traveler information (e.g., when a sufficient traveler information is already obtained, and any more information is not necessary, and obtaining further unnecessary information would delay traveler processing), or at least in some cases, may even obtain the absolute minimum of traveler information, e.g., to allow traveler processing to be performed, based on the various characteristics and conditions for the traveler or situation. In other cases, the computer 110 may decide the order in which to gather information, such that the threshold is met more quickly. Thus, in this manner, the traveler experience may be improved by more quickly and accurately identifying specifically what information is required for traveler processing. Also, by having traveler information that is of sufficient quality and reliability, this may improve the accuracy of the traveler processing. For example, by using one or more of the example techniques described herein, this may decrease the number of false positives (e.g., where a traveler was incorrectly identified in a check) and/or false negatives (e.g., where a check in the traveler processing missed an issue or problem with a traveler). Thus, for example, by configuring computer 110 with a reliability score for each of a plurality of information collection modes under various conditions or for various characteristics, and then comparing a cumulative score to a threshold or a confidence interval, traveler processing may be improved. For example, by omitting or rejecting (or at least decreasing a reliability score of) a face scan received under poor lighting conditions (e.g., where such face scan under such lighting would be unreliable), and/or by omitting or rejecting (or at least decreasing a reliability score of) a fingerprint under poor environmental conditions, and requiring a different or better or more reliable (e.g., with a higher reliability score) biometric scan for those conditions and/or for a particular traveler/person, a better and/or improved traveler processing may be provided which may be more reliable, more adaptive to the characteristics or conditions of a particular situation, while, at least in some cases, reducing traveler processing time.

As noted, computer 110 may decide the order in which to gather or collect traveler information (e.g., including one or more biometric scans of the traveler), such that the threshold or confidence interval is met more quickly. For example, computer 110 may receive a traveler document (which may indicate, e.g., a characteristic(s) of the traveler, such as race, skin color, country of origin, occupation, age, . . . ) and/or detect one or more environmental conditions at the checkpoint. In an example implementation, the computer 110 may then, e.g., based on the characteristic(s) of the traveler and/or one or more environmental conditions (or based on other information), may determine or estimate a reliability score for each of a plurality of information collection modes (or for each of a plurality of biometric modes), and may then rank (e.g., based on their reliability scores) these plurality of information collection modes or biometric modes for this traveler and under these environmental conditions, for example. The computer 110 may then request and/or collect traveler information (e.g., biometric scans of the traveler) in an order which may be estimated by the computer 110 to most quickly and/or most efficiently (e.g., fewest required biometric scans) meet a threshold or confidence interval, e.g., based on a fewest amount or number of biometric scans or based on quickest estimated time for information collection and processing, or other criteria. For example, if the computer 110 determines that one of the biometric scans, combined with the received travel document, would meet the required threshold or confidence interval, then the computer 110 may then request and obtain that biometric scan first from the traveler, e.g., so as to speed up traveler processing, for example. If that first biometric scan is unable to meet the threshold for the traveler, then computer 110 may then obtain additional biometric scans/biometric information for the traveler. In this manner, a more efficient traveler processing may be provided, e.g., which may result in fewer biometric scans being required and/or less time for traveler processing.

### Example 1

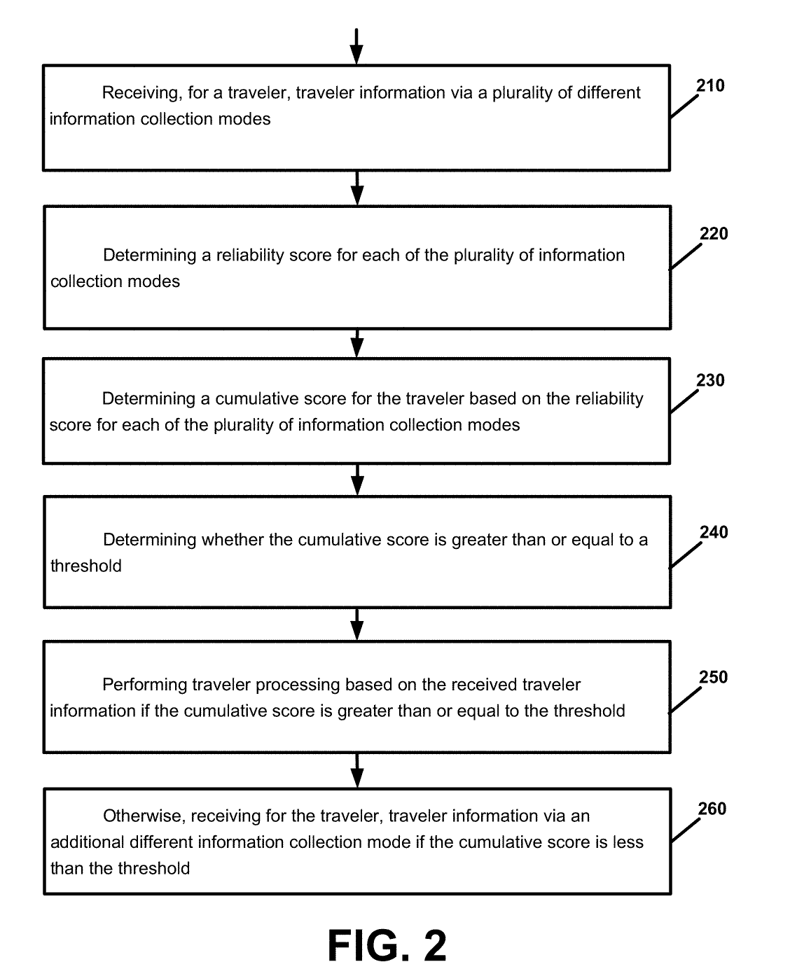

FIG. 2 is a flow chart illustrating operation of a computer according to an example implementation. Operation 210 includes receiving, for a traveler, traveler information via a plurality of different information collection modes. Operation 220 includes determining a reliability score for each of the plurality of information collection modes. Operation 230 includes determining a cumulative score for the traveler based on the reliability score for each of the plurality of information collection modes. Operation 240 includes determining whether the cumulative score is greater than or equal to a threshold. Operation 250 includes performing traveler processing based on the received traveler information if the cumulative score is greater than or equal to the threshold. And, operation 260 includes otherwise, receiving for the traveler, traveler information via an additional different information collection mode if the cumulative score is less than the threshold.

### Example 2

According to an example implementation of the method of example 1, wherein the plurality of different information collection modes comprises at least a travel document for the traveler and a biometric scan for the traveler.

### Example 3

According to an example implementation of the method of any of examples 1-2, wherein the receiving, for a traveler, traveler information via a plurality of different information collection modes comprises receiving two or more of the following for the traveler: a scan of a travel document for the traveler; a fingerprint scan of the traveler; a palm print scan of the traveler; a face scan of the traveler; an iris scan of the traveler; and a hand vein scan of the traveler.

### Example 4

According to an example implementation of the method of any of examples 1-3, wherein the travel document comprises at least one of the following: a passport; a visa; an airline boarding pass; a national identification card; and a driver's license.

### Example 5

According to an example implementation of the method of any of examples 1-4, wherein the determining a reliability score for each of the plurality of information collection modes comprises: determining a reliability score for each of the plurality of information collection modes based on one or more of the following: a characteristic of a travel document for the traveler where the information collection mode comprises a travel document for the traveler; a characteristic of the traveler; an environmental condition; and a number of biometric scan entries in a database; a characteristic of a device used to perform a biometric scan where the information collection mode comprises a biometric scan of the traveler.

### Example 6

According to an example implementation of the method of any of examples 1-5, wherein the characteristics of the travel document for the traveler comprises one or more of the following characteristics: a type of travel document; a country that issued the travel document; whether the travel document is hand-written or typed; whether or not the travel document includes or uses one or more of the following security features: a digitally-printed photograph; a watermark; a radio frequency identification (RFID) chip; thermochromatic ink; and a hologram.

### Example 7

According to an example implementation of the method of any of examples 1-6, wherein the characteristic of the traveler comprises one or more of the following: a race of the traveler; a skin color of the traveler; a country of origin of the traveler; an occupation of the traveler; an age of the traveler.

### Example 8

According to an example implementation of the method of any of examples 1-7, wherein the environmental condition comprises one or more of the following environmental conditions: a temperature; a humidity; and a lighting condition.

### Example 9

According to an example implementation of the method of any of examples 1-8 wherein the characteristic of a device used to perform a biometric scan comprises one or more of the following: a type of the device; a model or manufacturer of the device; age of the device; speed of the device to perform a biometric scan; quality of the data capture when the device performs a biometric scan; one or more performance characteristics of the device; and one or more environmental conditions recommended or required for operation of the device.

### Example 10

According to an example implementation of the method of any of examples 1-9, wherein the performing traveler processing based on the received traveler information comprises performing one or more of the following: a traveler verification process in which it is verified that the received traveler information for the plurality of different information collection modes is consistent or for the same traveler; a background check for the traveler to determine if at least a portion of the received traveler information matches information stored in one or more background check lists; and an identity fraud check in which it is determined whether at least a portion of the received traveler information was previously presented or received for a different traveler.

### Example 11

According to an example implementation of the method of any of examples 1-10, wherein the otherwise, receiving for the traveler, traveler information via an additional different information collection mode if the cumulative score is less than the threshold comprises: ranking a plurality of remaining information collection modes; and receiving for the traveler, traveler information via a highest ranked additional different information collection mode among the plurality of remaining information collection modes.

### Example 12

According to an example implementation of the method of any of examples 1-11, wherein the plurality of different information collection modes comprises a travel document and a plurality of different biometric modes, wherein the receiving, for a traveler, traveler information via a plurality of different information collection modes comprises: ranking, based on a reliability score, a plurality biometric modes; and receiving, for a traveler, at least a travel document for the traveler and highest ranked biometric scan for the traveler.

### Example 13

According to an example implementation, an apparatus comprises at least one processor and at least one memory including computer instructions, when executed by the at least one processor, cause the apparatus to perform a method of any of examples 1-12.

### Example 14

According to an example implementation, an apparatus comprises means for performing a method of any of examples 1-12.

### Example 15

An apparatus comprising at least one processor and at least one memory including computer instructions, when executed by the at least one processor, cause the apparatus to: receive, for a traveler, traveler information via a plurality of different information collection modes; determine a reliability score for each of the plurality of information collection modes; determine a cumulative score for the traveler based on the reliability score for each of the plurality of information collection modes; determine whether the cumulative score is greater than or equal to a threshold or within a confidence interval; perform traveler processing based on the received traveler information if the cumulative score is greater than or equal to the threshold; and otherwise, receive for the traveler, traveler information via an additional different information collection mode if the cumulative score is less than the threshold or outside the confidence interval.

### Example 16

A non-transitory computer-readable storage medium comprising instructions stored thereon, when executed by at least one processor, are configured to cause at least one computing system to at least: determine the order in which to collect information; receive, for a traveler, traveler information via a plurality of different information collection modes; determine a reliability score for each of the plurality of information collection modes; determine a cumulative score for the traveler based on the reliability score for each of the plurality of information collection modes; determine whether the cumulative score is greater than or equal to a threshold or within a confidence interval; perform traveler processing based on the received traveler information if the cumulative score is greater than or equal to the threshold or within a confidence interval; and otherwise, receive for the traveler, traveler information via an additional different information collection mode if the cumulative score is less than the threshold or outside a confidence interval.

### Example 17

A non-transitory computer-readable storage medium comprising instructions stored thereon, when executed by at least one processor, are configured to cause at least one computer or processor to perform the method of any of examples 1-12.

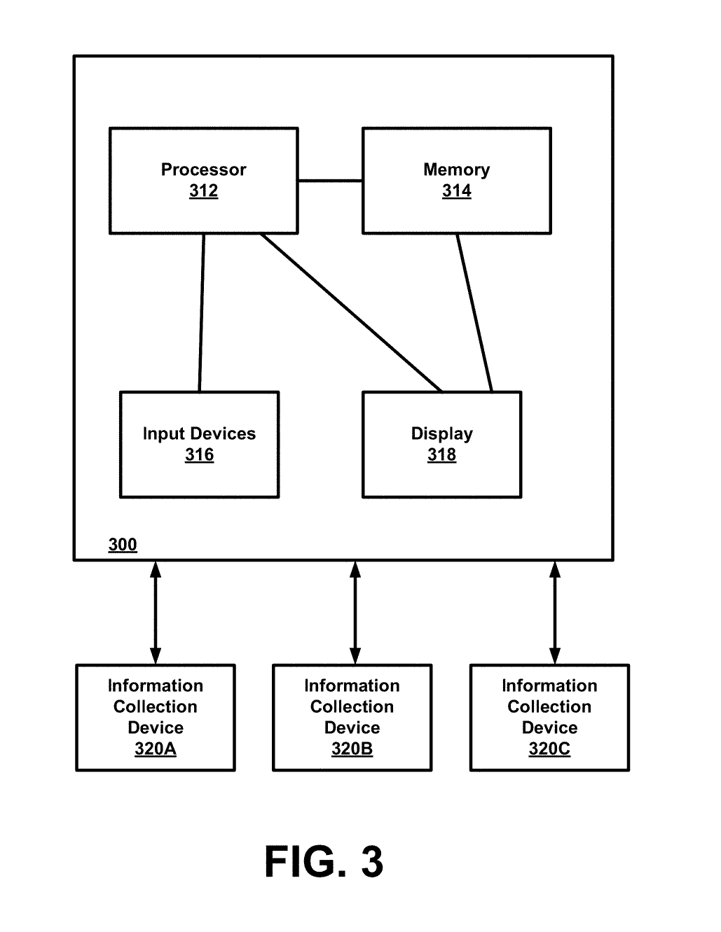

FIG. 3 is a block diagram of a system, such as computer 110, according to an example implementation. The system shown in FIG. 3 may include a computer 300 (e.g., such as computer 110 shown in FIG. 1). Computer 300 may include a processor 312 for executing software or instructions, memory 314 (e.g., including random access memory (RAM), and/or a hard disk drive (HDD)) for storing software (or computer instructions) and data. Computer 300 may also include one or more input devices 316, such as, for example, a mouse or pointing device, a keyboard, etc. Computer 300 may also include a display 318 or monitor for displaying information. Computer 300 may be connected to or in communication with a plurality of traveler information collection devices, such as information collection devices 320A, 320B, 320C, etc. The traveler information collection devices may include a variety of devices to collect different modes (e.g., different types or different modes) of traveler information, such as a document scanner, fingerprint scanner, palm print scanner, iris scanner, face scanner, or other information collection device and/or biometric scanner.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks.

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer (or a single processor or single core processor) or it may be distributed among and/or executed by a plurality of computers (or processed by a plurality of processors or a multi-core processor(s)).

A computer program, such as the computer program(s) described above, e.g., which when executed, may cause computer 110 to perform one or more or even all of the functions and tasks described herein (e.g., such as to determine collection order, collect traveler information from one or more information collection devices, determine a reliability score for one or more traveler information or scan, determine a cumulative score based on the reliability scores of the received traveler information, determine whether the cumulative score is greater than or equal to a threshold or within a confidence interval, performing traveler processing if the cumulative score is greater than or equal to the threshold or within a confidence interval, and otherwise receiving or obtaining an additional traveler information, e.g., via another or a different information collection mode or biometric mode, updating the cumulative score, and then performing traveler processing if the updated cumulative score is greater than or equal to a threshold or within a confidence interval), can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server (for example, servers 114A, 114B where one or more checks for the traveler may be performed and results returned to computer 110 or computer 300), or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. A method comprising:
receiving, for a traveler, traveler information via a plurality of different information collection modes;
determining a reliability score for each of the plurality of information collection modes;
determining a cumulative score for the traveler based on the reliability score for each of the plurality of information collection modes;
determining whether the cumulative score is greater than or equal to a threshold;
performing traveler processing based on the received traveler information if the cumulative score is greater than or equal to the threshold; and
otherwise, receiving for the traveler, traveler information via an additional different information collection mode if the cumulative score is less than the threshold.

2. The method of claim 1 wherein the plurality of different information collection modes comprises at least a travel document for the traveler and a biometric scan for the traveler.

3. The method of claim 1 wherein the receiving, for a traveler, traveler information via a plurality of different information collection modes comprises receiving two or more of the following for the traveler:
a scan of a travel document for the traveler;
a fingerprint scan of the traveler;
a palm print scan of the traveler;
a face scan of the traveler;
an iris scan of the traveler; and
a hand vein scan of the traveler.

4. The method of claim 3 wherein the travel document comprises at least one of the following:
a passport;
a visa;
an airline boarding pass;
a national identification card; and
a driver's license.

5. The method of claim 1 wherein the determining a reliability score for each of the plurality of information collection modes comprises:
determining a reliability score for each of the plurality of information collection modes based on one or more of the following:
a characteristic of a travel document for the traveler where the information collection mode comprises a travel document for the traveler;
a characteristic of the traveler;
an environmental condition; and
a number of biometric scan entries in a database;
a characteristic of a device used to perform a biometric scan where the information collection mode comprises a biometric scan of the traveler.

6. The method of claim 5 wherein the characteristics of the travel document for the traveler comprises one or more of the following characteristics:
a type of travel document;
a country that issued the travel document;
whether the travel document is hand-written or typed;
whether or not the travel document includes or uses one or more of the following security features:
a digitally-printed photograph;
a watermark;
a radio frequency identification (RFID) chip;
thermochromatic ink; and
a hologram.

7. The method of claim 5 wherein the characteristic of the traveler comprises one or more of the following:
a race of the traveler;
a skin color of the traveler;
a country of origin of the traveler;
an occupation of the traveler;
an age of the traveler.

8. The method of claim 5 wherein the environmental condition comprises one or more of the following environmental conditions:
a temperature;
a humidity; and
a lighting condition.

9. The method of claim 5 wherein the characteristic of a device used to perform a biometric scan comprises one or more of the following:
a type of the device;
a model or manufacturer of the device;
age of the device;
speed of the device to perform a biometric scan;
quality of the data capture when the device performs a biometric scan;
one or more performance characteristics of the device; and
environmental conditions recommended or required for operation of the device.

10. The method of claim 1 wherein the performing traveler processing based on the received traveler information comprises performing one or more of the following:
a traveler verification process in which it is verified that the received traveler information for the plurality of different information collection modes is consistent or for the same traveler;
a background check for the traveler to determine if at least a portion of the received traveler information matches information stored in one or more background check lists; and
an identity fraud check in which it is determined whether at least a portion of the received traveler information was previously presented or received for a different traveler.

11. The method of claim 1 wherein the otherwise, receiving for the traveler, traveler information via an additional different information collection mode if the cumulative score is less than the threshold comprises:
ranking a plurality of remaining information collection modes; and
receiving for the traveler, traveler information via a highest ranked additional different information collection mode among the plurality of remaining information collection modes.

12. The method of claim 1, wherein the plurality of different information collection modes comprises a travel document and a plurality of different biometric modes, wherein the receiving, for a traveler, traveler information via a plurality of different information collection modes comprises:
ranking, based on a reliability score, a plurality biometric modes; and
receiving, for a traveler, at least a travel document for the traveler and highest ranked biometric scan for the traveler.

13. An apparatus comprising at least one processor and at least one memory including computer instructions, when executed by the at least one processor, cause the apparatus to perform a method of claim 1.

14. An apparatus comprising means for performing the method of claim 1.

15. An apparatus comprising at least one processor and at least one memory including computer instructions, when executed by the at least one processor, cause the apparatus to:
determine an order in which to collect information;
receive, for a traveler, traveler information via a plurality of different information collection modes;
determine a reliability score for each of the plurality of information collection modes;
determine a cumulative score for the traveler based on the reliability score for each of the plurality of information collection modes;
determine whether the cumulative score is greater than or equal to a threshold;
perform traveler processing based on the received traveler information if the cumulative score is greater than or equal to the threshold; and
otherwise, receive for the traveler, traveler information via an additional different information collection mode if the cumulative score is less than the threshold.

16. A non-transitory computer-readable storage medium comprising instructions stored thereon, when executed by at least one processor, are configured to cause at least one computing system to at least:
receive, for a traveler, traveler information via a plurality of different information collection modes;
determine a reliability score for each of the plurality of information collection modes;
determine a cumulative score for the traveler based on the reliability score for each of the plurality of information collection modes;
determine whether the cumulative score is greater than or equal to a threshold;
perform traveler processing based on the received traveler information if the cumulative score is greater than or equal to the threshold; and
otherwise, receive for the traveler, traveler information via an additional different information collection mode if the cumulative score is less than the threshold.
